(19) United States
(12) Patent Application Publication
(10) Pub. No.: US 2019/0176544 A1
(43) Pub. Date: Jun. 13, 2019

(54) TIRE PRESSURE MONITORING SYSTEM

(71) Applicant: DENSO CORPORATION, Kariya-city, Aichi-pref. (JP)

(72) Inventors: Haruyuki IKEO, Kariya-city (JP); Noriaki OKADA, Kariya-city (JP)

(21) Appl. No.: 16/327,378

(22) PCT Filed: Sep. 4, 2017
(86) PCT No.: PCT/JP2017/031841

§ 371 Date: Feb. 22, 2019

(30) Foreign Application Priority Data
Sep. 8, 2016 (JP) 2016-175860

(51) Int. Cl. B60C 23/04

(52) U.S. Cl. CPC B60C 23/0433; B60C 23/0401; B60C 23/0416; B60C 23/0493

(57) ABSTRACT

A sensor transceiver is kept in a state capable of receiving LF waves. Upon receiving LF waves indicating a start command from the vehicle-body system, the sensor transceiver is caused to be in a state capable of receiving RF waves accordingly. Upon receiving an instruction command from the vehicle-body system under the state capable of receiving RF waves, the sensor transceiver notifies the vehicle-body system of data on tire pressure.

### CROSS REFERENCE TO RELATED APPLICATION

This application is based on Japanese Patent Application No. 2016-175860 filed on Sep. 8, 2016, the disclosure of which is incorporated herein by reference.

### TECHNICAL FIELD

The present disclosure relates to a tire pressure monitoring system (hereinafter referred to as TPMS: Tire Pressure Monitoring System).

### BACKGROUND

There is conventionally known a direct-type tire pressure monitoring system as one of tire pressure monitoring systems (e.g., refer to Patent literature 1). In such a direct-type TPMS, a sensor transmitter including a pressure sensor is provided to be directly attached to a wheel which a tire of a vehicle is attached to; in contrast, an antenna and a receiver are provided in the vehicle itself. When the sensor transmitter transmits a detection result as a detection signal of the pressure sensor, the detection signal is received by the receiver via the antenna. This allows the detection of the tire pressure.

In the above TPMS, the tire pressure is detected while the ignition switch (hereinafter referred to as IG) of the vehicle is in ON state. Thus, the information on tire pressure available immediately after the IG transitions into ON state is only the information on tire pressure collected before the vehicle is parked; therefore, the tire pressure cannot be detected based on the information on tire pressure during OFF state of the IG. Therefore, an occurrence of abnormality in tires may be recognized for the first time after the vehicle is started to run, due to an abnormality in ride comfort of the vehicle.

### PRIOR ART LITERATURE

### Patent Literature

Patent Literature 1: JP 2007-015491 A

### SUMMARY OF INVENTION

In the TPMS, the power of the receiver is turned off during parking; the tire pressure is detected only during ON state of the IG. Further, the tire pressure is not detected immediately after the IG transitions into ON state. It is thus desired that the tire pressure is detected as soon as possible after the IG transitions into ON state. To response thereto, it is conceivable to send a command on LF (abbreviation of Low Frequency) waves from the vehicle to the sensor transmitter so as to command the sensor transmitter to transmit the air pressure information immediately after the IG transitions into ON state. However, the LF waves have a disadvantage suffering from a slow data transfer rate. If only the command is sent so as to detect it early, the received multiple sensor transmitters simultaneously transmit RF waves, resulting in interference state. In addition, in order to avoid such interference state, techniques may be provided which attach the ID information of a specified sensor transmitter to a command and transmit such a command to the specified sensor transmitter. Such techniques need to be performed for the respective sensor transmitters of the wheels; this increases the delay time unsuitably. Further, a different technique, which sends a command on LF waves from the vehicle immediately after the IG transitions into ON state, may include, as a sensor transmitter, a sensor transceiver capable of receiving RF (Radio Frequency) waves. That is, in the different technique, the RF waves may be outputted from the vehicle immediately after the IG transitions into ON state so as to notify a sensor transceiver of the IG ON and to cause the sensor transceiver to transmit the data on tire pressure. This technique however needs to constantly supply the power for the sensor transceiver to constantly receive RF waves, resulting in an increase in current consumption. The sensor transceiver is arranged internally in the tire; the current consumption needs to be reduced in consideration of the battery life. When RF waves being high frequency range can always be received, power consumption is particularly large.

It is an object of the present disclosure to provide a TPMS capable of detecting a tire pressure earlier while suppressing an increase in current consumption.

According to an aspect of the present disclosure, a TPMS is provided to include a plurality of sensor transceivers and a vehicle-body system provided in a vehicle body of a vehicle. Each of the sensor transceivers includes: a sensing unit configured to detect a tire pressure of a tire of a corresponding wheel of the plurality of wheels; a first control unit configured to prepare a frame that stores data on the tire pressure and performs transmission of the frame; an RF reception unit configured to receive RF waves that indicate an instruction command instructing transmission of the data on the tire pressure; and an LF reception unit configured to receive LF waves that indicate a start command to cause the RF reception unit to be in a state capable of receiving RF waves. The vehicle-body system includes: a reception unit configured to receive received frames that are frames transmitted respectively from the sensor transceivers; a second control unit configured to detect tire pressures of the tires of the plurality of wheels respectively based on the received frames; an LF transmission unit configured to transmit LF waves; an RF transmission unit configured to transmit RF waves. Herein, in the vehicle-body system, upon detecting that a start switch manipulated to cause the vehicle to start to run is switched from OFF state into ON state, the second control unit (i) causes the LF transmission unit to transmit LF waves, and, then, (ii) causes the RF transmission unit to transmit RF waves during a predetermined period of time. Further, in each of the sensor transceivers, upon receiving LF waves via the LF reception unit, the first control unit (i) causes the RF reception unit to be in a state capable of receiving RF waves, (ii) causes the RF reception unit to receive RF waves transmitted after receiving the LF waves, and (iii) performs transmission of the frame as a response to the received RF waves.

According to the aspect, each of the sensor transceivers is kept in a state capable of receiving LF waves. Upon receiving LF waves indicating a start command from the vehicle-body system, each of the sensor transceivers is caused to be in a state capable of receiving RF waves accordingly. Upon receiving an instruction command from the vehicle-body system under the state capable of receiving RF waves, each of the sensor transceivers notifies the vehicle-body system of data on tire pressure. Such a configuration only requires the sensor transceivers to be in a state capable of receiving LF waves with little standby current, without need of keeping the sensor transceivers in a state capable of receiving RF waves all the time. The current consumption can thus be reduced. This provides a TPMS capable of detecting tire pressure earlier while suppressing an increase in current consumption.

### BRIEF DESCRIPTION OF DRAWINGS

FIG. 1 is a diagram showing an overall configuration of a TPMS according to a first embodiment;

FIG. 2 is a block diagram showing details of a sensor transceiver;

FIG. 3 is a block diagram showing details of a vehicle-body system;

FIG. 4 is a flowchart showing details of a startup detection process;

FIG. 5 is a flowchart showing details of a startup response process; and

FIG. 6 is a time chart of the TPMS according to the first embodiment.

### DETAILED DESCRIPTION

Embodiments of the present disclosure will be described below with reference to the drawings. In the following embodiments, the description will be made by denoting the same or equivalent parts by the same reference numerals or signs.

### First Embodiment

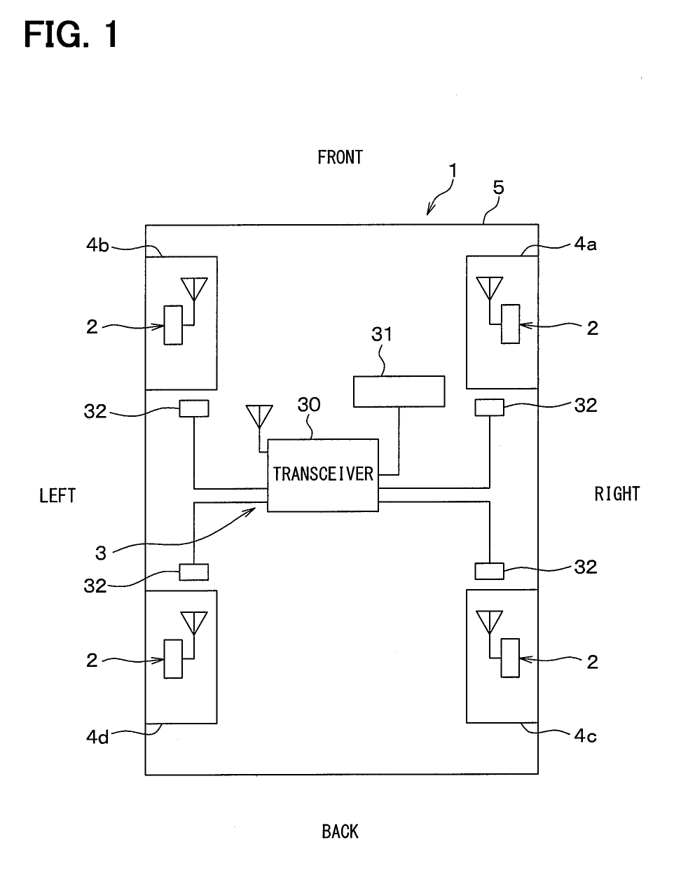

The first embodiment will be described with reference to FIGS. 1 to 6. FIG. 1 is a block diagram showing an overall configuration of a TPMS (i.e., Tire Pressure Monitoring System) in a vehicle 1 according to the present embodiment. The top and the bottom of FIG. 1 correspond, respectively, to the front and the back of the vehicle 1.

As shown in FIG. 1, the TPMS, which is attached to the vehicle 1, includes (i) a plurality of sensor transceivers 2 and (ii) a vehicle-body system 3.

As shown in FIG. 1, the sensor transceiver 2 (i.e., each of the sensor transceivers 2) is attached one by one to each of the wheels 4a to 4d of the vehicle 1. The sensor transceiver 2 functions primarily as a transmitter; the transmitter detects an air pressure (also referred to as a tire pressure) of a tire attached to each of the wheels 4a to 4d and a temperature (also referred to as an inside temperature) inside of the tire repeatedly every predetermined periodical transmission cycle, and the transmitter then transmits a frame that stores the data of a detection signal indicating a detection result. In addition, the sensor transceiver 2 also functions as a receiver which receives LF waves or RF waves transmitted from the vehicle-body system 3 as described later. When receiving the RF waves after receiving the LF waves, the sensor transceiver 2 also detects a tire pressure and an inside temperature as a detection result, and transmits a frame that stores the data indicating the detection result.

In contrast, the vehicle-body system 3, which is provided in the vehicle body 5 of the vehicle 1, receives a frame transmitted from each of the sensor transceivers 2 while performing various processes, calculations, etc., based on the data stored in the frame, to thereby obtain a tire pressure. Further, the vehicle-body system 3 is configured to transmit LF waves or RF waves to the sensor transceivers 2 when the IG (unshown) transitions into ON state. Each of the sensor transceivers 2 is thereby caused to transmit a detection result of a tire pressure and an inside temperature of the corresponding tire promptly to the vehicle-body system 3. The vehicle-body system 3 warns a user by notifying the user of an abnormality in the tire pressure, if such an abnormality is found from the detection result transmitted from each of the sensor transceivers 2.

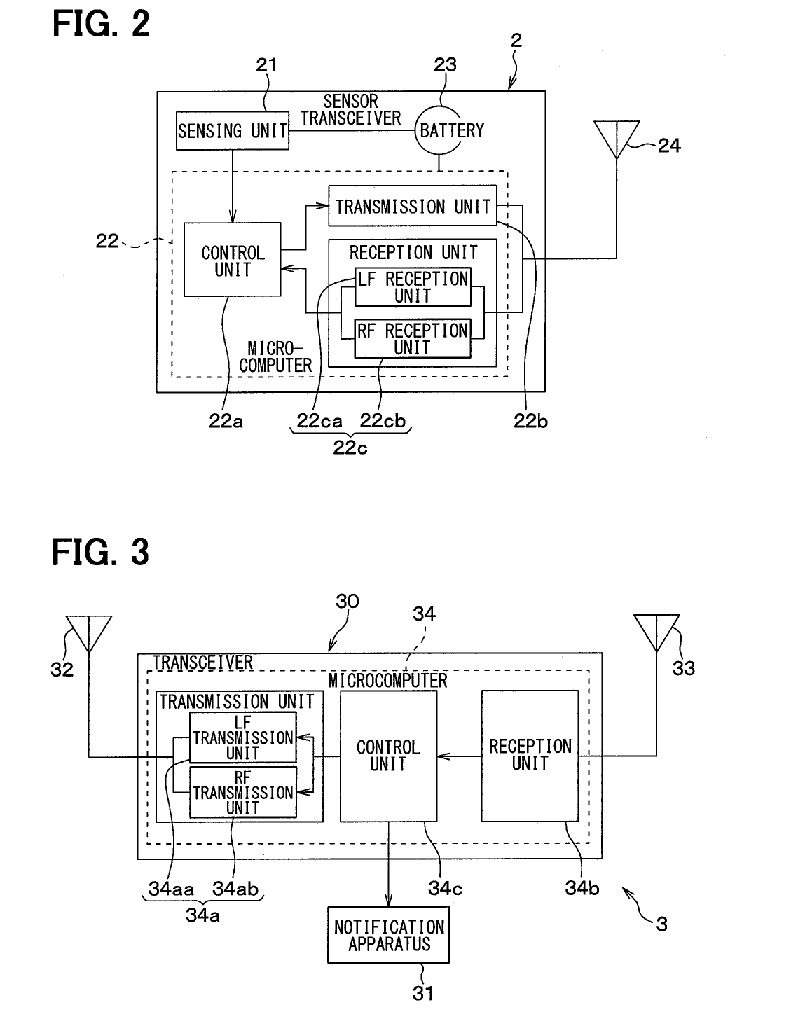

Detailed configurations of (i) each of the sensor transceivers 2 and (ii) the vehicle-body system 3 will be described with reference to FIGS. 2 and 3.

As shown in FIG. 2, the sensor transceiver 2 includes a sensing unit 21, a microcomputer 22, a battery 23, and an antenna 24.

The sensing unit 21 is configured to include a pressure sensor and a temperature sensor, and to output a detection signal indicating a tire pressure and an inside temperature of a tire (hereinafter referred to as a detection signal on tire pressure). The sensing unit 21 detects a tire pressure and an inside temperature of the tire every transmission cycle repeatedly based on an instruction from the microcomputer 22.

The microcomputer 22, which is a well-known microcomputer including a CPU, a ROM, a RAM, and an I/O, executes predetermined processes according to programs stored in the ROM or the like. Specifically, the microcomputer 22 includes a control unit 22a (which corresponds to a first control unit), a transmission unit 22b, and a reception unit 22c; the microcomputer 22 performs various processes related to tire pressure monitoring in accordance with programs stored in a built-in memory of the control unit 22a.

Specifically, the control unit 22a performs as follows: receiving a detection signal on tire pressure from the sensing unit 21 repeatedly every predetermined detection cycle; performing signal processing on the detection signal while processing the detection signal as needed; storing the data indicating a detection result (hereinafter referred to as data on tire pressure) onto a frame along with a unique identification information-item (hereinafter referred to as an ID information-item) of each sensor transceiver 2; and transmitting the frame to the transmission unit 22b. The above process of transmitting the signal to the transmission unit 22b is executed repeatedly every predetermined periodic transmission cycle in accordance with the above program.

Also, when being notified of an instruction command instructing transmission of data on tire pressure by the vehicle-body system 3, the control unit 22a also stores the data on tire pressure together with the ID information-item in the frame and transmits it to the transmission unit 22b. Therefore, even in a transmission time frame that is different from a time frame every a predetermined periodical transmission cycle, the data on tire pressure is enabled to be transmitted to the transmission unit 22b.

The transmission unit 22b functions as an output unit that transmits a frame sent from the control unit 22a to the vehicle-body system 3 via the antenna 24. In the present embodiment, the transmission unit 22b is configured as an RF transmission unit that performs transmission of a frame on RF waves.

The reception unit 22c functions as an input unit that receives LF waves or RF waves sent from the vehicle-body system 3 via the antenna 24. The reception unit 22c includes an LF reception unit 22ca for receiving LF waves and an RF reception unit 22cb for receiving RF waves.

The LF reception unit 22ca is always operated so that the LF waves indicating a start command can be received all the time. The LF waves are a low frequency range; thus, the reception of the LF waves does not require significant standby current. The current consumption in the LF reception unit 22ca may be reduced. Further, when receiving the LF waves, the LF reception unit 22ca notifies the control unit 22a of the reception of the LF waves. The control unit 22a thus issues a start instruction to instruct the RF reception unit 22cb to be capable of receiving RF waves in a predetermined period of time.

The RF reception unit 22cb is capable of receiving RF waves indicating an instruction command in an intended time frame. Here, when a start instruction is sent from the control unit 22a after the LF reception unit 22ca receives the LF waves, the RF reception unit 22cb transitions into a state capable of receiving RF waves during a predetermined period of time. Further, when receiving the RF waves transmitted from the vehicle-body system 3 during the predetermined period of time, the RF reception unit 22cb notifies the control unit 22a of the reception of the RF waves, which correspond to a signal indicating an instruction command. The control unit 22a thereby stores the data on tire pressure together with the ID information-item in the frame and sends it to the transmission unit 22b.

Note that the instruction command also includes the ID information-item of each sensor transceiver 2; each sensor transceiver 2 transmits data on tire pressure when receiving RF waves indicating an instruction command including its own ID information-item. Thus, the respective sensor transceivers 2 perform the respective frame transmissions with the respective transmission time frames not overlapping with each other. This may prevent the vehicle-body system 3 from failing to receive the frames due to the overlapping of the transmission time frames.

Here, suppose cases where the RF reception unit 22cb is in a state capable of receiving RF waves. In such cases, since the RF waves are a high frequency range, the standby current may be large to increase the current consumption significantly. However, in the present embodiment, the RF reception unit 22cb is not always operated, but operated only during a predetermined period of time after the LF reception unit 22ca receives the LF waves. An increase in the current consumption may thus be suppressed.

The battery 23 supplies power to the control unit 22a and the like. Upon receipt of power supplied from the battery 23, the sensing unit 21 can perform the collection of data on tire pressure and the control unit 22a can perform various calculations. The sensor transceiver 2 is provided in each tire; the replacement of the battery 23 is not easy, and the suppression of current consumption is thus required. Shortening the period of time in which the RF reception unit 22cb is actuated, as described above, can thus provide an effect to suppress the current consumption.

The antenna 24 receives LF waves and RF waves transmitted from the vehicle-body system 3. The LF waves and the RF waves are received by the antenna 24; the antenna 24 need not be one antenna and may be configured to be separate antennas for LF wave reception and for RF wave reception.

The sensor transceiver 2 is attached to, for example, an air injection valve provided in each of the wheels 4a to 4d; the sensing unit 21 is provided to be exposed to an inside of the tire. The sensor transceiver 2 thus detects a tire pressure of the corresponding wheel and transmits a frame storing data on tire pressure through the antenna 24 every predetermined periodic transmission cycle, for example, every one minute. In addition, the sensor transceiver 2 also transmits a frame storing data on tire pressure. That is, the sensor transceiver 2 receives LF waves indicating a start command from the vehicle-body system 3 in response to that the IG transitions into ON state, and then receives RF waves indicating an instruction command from the vehicle-body system 3. Thereby, the sensor transceiver 2 is caused to detect a tire pressure at that point of time and transmit a frame storing data on the tire pressure.

The data on tire pressure is sent together with the ID information-item of the sensor transceiver 2. The position of each wheel can be specified by a well-known wheel position detection apparatus that detects which position of the vehicle each of the wheels is attached to. Transmitting of the data on tire pressure to the transceiver 30 together with the ID information-item thus enables the determination of, among the wheels, the wheel which the data comes from.

In contrast, as shown in FIG. 3, the vehicle-body system 3 is configured to include a transceiver 30 and a notification apparatus 31. Each unit or the like included in the vehicle-body system 3 is connected through an in-vehicle LAN (Local Area Network) like CAN (Controller Area Network) communication. Thus each unit or the like is capable of communicating information mutually through the in-vehicle LAN.

The transceiver 30 includes a transmission antenna 32, a reception antenna 33, and a microcomputer 34.

The transmission antenna 32, which outputs LF waves indicating a start command and RF waves indicating an instruction command to each sensor transceiver 2, is fixed to the vehicle body 5. Although only one transmission antenna 32 is shown in FIG. 3, the transmission antennas 32 may be arranged to be one by one corresponding to the respective wheels 4a to 4d as shown in FIG. 1. As described later, the LF waves and the RF waves are transmitted by the transmission antenna 32; the transmission antenna 32 need not be one antenna and may be configured to be separate antennas for LF wave transmission and for RF wave transmission.

The reception antenna 33, which is one or a plurality of antennas which collectively receive frames transmitted on RF waves from each sensor transceiver 2, is fixed to the vehicle body 5.

The microcomputer 34, which is a well-known microcomputer including a CPU, a ROM, a RAM, and an I/O, executes predetermined processes according to programs stored in the ROM or the like. Specifically, the microcomputer 34 includes a transmission unit 34a, a reception unit 34b, and a control unit 34c (which corresponds to a second control unit); the microcomputer 34 performs various processes related to the tire pressure monitoring in accordance with programs stored in a built-in memory of the control unit 34c.

The transmission unit 34a functions as an output unit that transmits LF waves or RF waves via the transmission antenna 32. The transmission unit 34a includes an LF transmission unit 34aa for transmitting LF waves and an RF transmission unit 34ab for transmitting RF waves.

The LF transmission unit 34aa transmits the LF waves indicating a start command via the transmission antenna 32 in accordance with an instruction from the control unit 34c. That is, when the IG is switched from OFF state to ON state, the control unit 34c issues an instruction to instruct the transmission unit 34a to output the LF waves, thereby causing the transmission unit 34a to transmit the LF waves indicating a start command.

The RF transmission unit 34ab transmits RF waves indicating an instruction command instructing the sensor transceiver 2 to transmit data on tire pressure, via the transmission antenna 32 in accordance with an instruction from the control unit 34c. The instruction command also includes the ID information-item of a respective sensor transceiver 2 of the sensor transceivers 2. When receiving the RF waves indicating an instruction command including its own ID information-item, the respective sensor transceiver 2 transmits the data on tire pressure.

The reception unit 34b functions as an input unit that receives a frame from each sensor transceiver 2 via the reception antenna 33 and sends the frame to the control unit 34c.

The control unit 34c obtains a tire pressure by performing various signal processing, calculation, etc. based on the data relating to the tire pressure stored in the received frame, and determines the decrease in the tire pressure based on the obtained tire pressure. Specifically, the control unit 34c compares the tire pressure with a warning threshold value, and determines that the tire pressure is decreased in response to that the tire pressure becomes equal to or less than the warning threshold value. Then, when such a decrease in the tire pressure is detected, the control unit 34c outputs a signal indicating the decrease in the tire pressure to the notification apparatus 31. This informs the notification apparatus 31 that the tire pressure of any one of the tires of the wheels 4a to 4d is decreased.

Further, when the IG is switched from OFF state to ON state, the control unit 34c instructs the transmission unit 34a to output the LF waves indicating a start command. The LF waves are thus outputted from the transmission unit 34a via the transmission antenna 32, allowing the RF reception unit 22cb of each sensor transceiver 2 to become ready to receive RF waves. Further, after instructing the output of the LF waves, the control unit 34c sequentially outputs, on RF waves, instruction commands instructing the respective sensor transceivers 2 to transmit data on tire pressure. That is, the instruction commands on RF waves are transmitted, sequentially, the number of times corresponding to the number of the wheels 4a to 4d; a respective instruction command of the instruction commands is assigned with the ID information-item of the respective sensor transceiver 2. As a result, when the IG is switched from OFF state to ON state, the data on tire pressure is also sent from each sensor transceiver 2 to the transceiver 30, and a decrease in the tire pressure of each of the wheels 4a to 4d may be determined.

The notification apparatus 31, which is disposed in a place to be seen by a driver being a user during driving the vehicle 1, is installed in the instrument panel of the vehicle 1, for example. The notification apparatus 31 includes a meter display or an alarm lamp. When the control unit 34c of the transceiver 30 issues an instruction to report the decrease in the tire pressure, the notification apparatus 31 performs a display to that effect to thereby notify the driver of the decrease in the tire pressure.

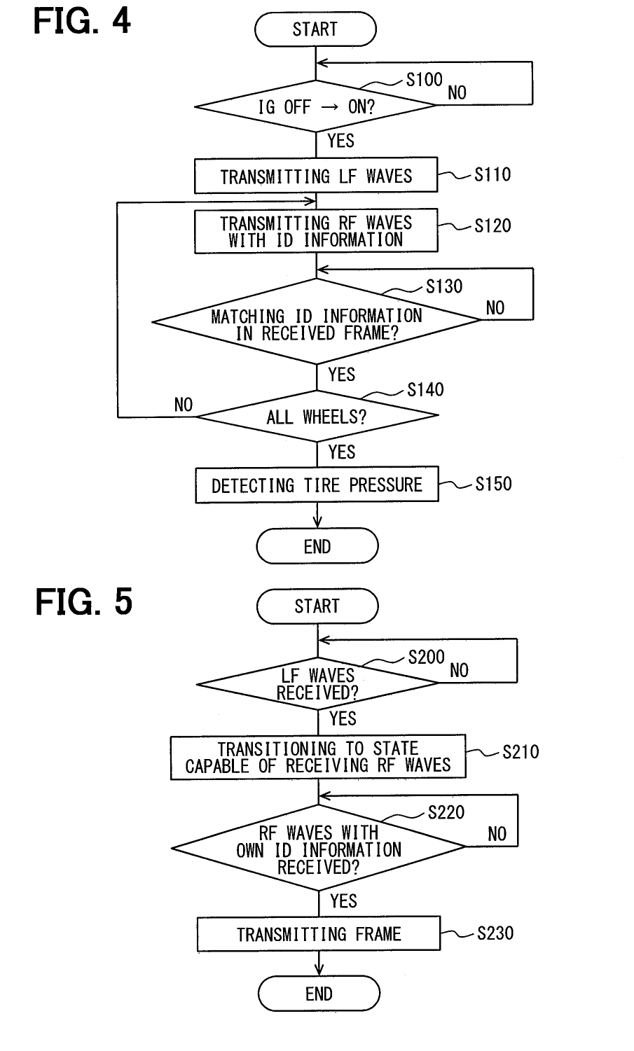

As described above, the TPMS according to the present embodiment is configured. Next, an operation example of the TPMS configured as described above will be described. Note that various operations of the TPMS include conventional operations such as various processes performed by the sensor transceiver 2 for periodical transmissions or a process of determining a decrease in tire pressure performed when the transceiver 30 receives a frame transmitted periodically. For this reason, the processing when the IG is switched from OFF state to ON state will be described with reference to FIGS. 4 and 5, without describing the conventional operations.

In the vehicle-body system 3, the control unit 34c executes a startup detection process shown in FIG. 4 repeatedly every predetermined control cycle.

First, in step S100, the control unit 34c determines whether the IG is switched from OFF state to ON state. When the IG is switched from OFF state to ON state, the process proceeds to step S110. In contrast, when it is determined in S100 that the IG is either (i) under OFF state or (ii) under ON continued state that is a state where the ON state continues after switched from OFF state to ON state, the process repeats step S100.

Next, in step S110, the transmission of the LF waves indicating a start command is instructed. The LF waves are thus transmitted from the LF transmission unit 34ab through the transmission antenna 32. When the LF waves are received by each sensor transceiver 2, each sensor transceiver 2 is enabled to be ready to receive RF waves.

In the following step S120, RF waves indicating an instruction command with a corresponding ID information-item are transmitted. Specifically, instead of attaching all the ID information-items of all the respective sensor transceivers 2 at one time, the mutually different ID information-items are attached, respectively, to the instruction commands on RF waves sequentially with control cycles so that ID information-items of the respective sensor transceivers 2 are, sequentially, attached to the instruction commands on RF waves and transmitted. In the present embodiment, the ID information-items of the sensor transceivers 2 are respectively attached and transmitted on RF waves to the four wheels 4a to 4d sequentially in the order of the right front wheel 4a, the left front wheel 4b, the right rear wheel 4c, and then the left rear wheel 4d. The ID information-items on RF waves are thereby received by the sensor transceivers 2. Then, a respective sensor transceiver 2 of the sensor transceivers 2 having an ID information-item matching with the received ID-information item eventually transmits the data on tire pressure.

The process then proceeds to step S130, where it is determined whether to receive the frame from the sensor transceiver 2 having the same ID information-item attached to the transmitted RF waves. When the frame is received, the process proceeds to step S140, where it is determined whether the processing of steps S120 and S130 has been performed for all of the four wheels 4a to 4d. Then, if it is performed for all, the process proceeds to step S150; if not, the processing of steps S120 and S130 is repeated.

Finally, in step S150, respective several data on tire pressure are read out from the received frames (i.e., the frames transmitted respectively from the sensor transceivers 2 of the wheels 4a to 4d, and it is determined whether or not a tire pressure is decreased. Then, if the tire pressure is decreased, the control circuit 34c instructs the notification apparatus 31 to notify of the decrease in the tire pressure, ending the process; if the tire pressure is not decreased, the control circuit 34c ends the process as it is.

In contrast, in a respective sensor transceiver 2 that is any one of the sensor transceivers 2, the control unit 22a performs a sensor response process shown in FIG. 5 repeatedly every predetermined control cycle.

First, in step S200, the control unit 22a determines whether LF waves indicating a start command is received. When receiving, the process proceeds to step S210; when not receiving, this processing is repeated. If the LF signal indicating a start command is transmitted from the vehicle-body system 3 based on that the IG is switched from OFF state to ON state, described above, the determination in this step is affirmatively made.

Next, in step 210, the RF reception unit 22cb is brought into a state capable of receiving RF waves during a predetermined period of time. This allows the reception of RF waves that are transmitted from the transceiver 30 after the reception of the LF waves from the transceiver 30, as described above.

Then, the process proceeds to step S220, where it is determined whether to receive RF waves attached with its own ID information-item. When receiving, the process proceeds to step S230; when not receiving, the present step is repeated until receiving. Thereafter, in step S230, data on tire pressure indicating a detection result in the sensing unit 21 is stored in the frame together with its own ID information-item, and this frame is transmitted to the transceiver 30.

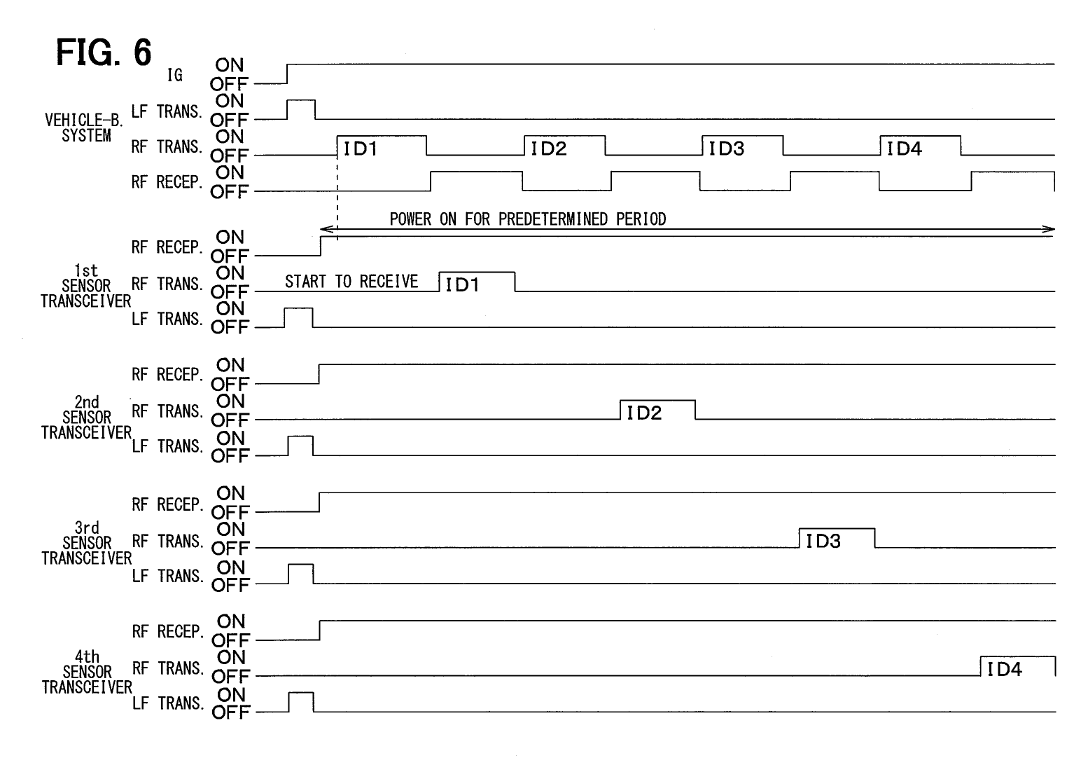

FIG. 6 is a time chart taking place when the above operations are performed.

As shown in FIG. 6, when the IG is switched from OFF state to ON state, the transceiver 30 of the vehicle-body system 3 transmits LF waves. When receiving the LF waves, the sensor transceivers 2 are individually in a state capable of receiving RF waves during a predetermined period of time. During this predetermined period of time, the RF waves with the ID information-items of the sensor transceivers 2 are respectively transmitted from the transceiver 30 sequentially with different transmission time frames. Under the configuration, a plurality of data on tire pressure are transmitted on RF waves from the sensor transceivers 2 having the respective IDs of ID1 to ID4 corresponding to the ID information-items attached on RF waves sequentially; this allows the tire pressures of the respective wheels 4a to 4d to be transmitted to the vehicle-body system 3.

The above-described TPMS according to the present embodiment is provided as follows. The sensor transceivers 2 are maintained in a state capable of receiving LF waves. When LF waves indicating a start command are sent from the vehicle-body system 3, the sensor transceivers 2 accordingly each transition into a state capable of receiving RF waves. Under the state capable of receiving RF waves, each of the sensor transceivers 2 is enabled to eventually transmit data on tire pressure to the vehicle-body system 3 based on a corresponding instruction command from the vehicle-body system 3. The detection of the tire pressures is thus enabled to be earlier.

Such a configuration only requires the sensor transceivers 2 to be in a state capable of receiving LF waves with little standby current, without need of keeping the sensor transceivers 2 in a state capable of receiving RF waves all the time. The current consumption can thus be reduced. This provides a TPMS capable of detecting tire pressure earlier while suppressing an increase in current consumption.

### OTHER EMBODIMENTS

Although the present disclosure is made based on the embodiment described above, the present disclosure is not limited to such an embodiment but includes various changes and modifications which are within equivalent ranges. Furthermore, various combination and formation, and other combination and formation including one, more than one or less than one element may be made within the spirit and scope of the present disclosure.

For example, in the above-described embodiment, each sensor transceiver 2 is set in a state capable of receiving RF waves during a predetermined period of time. That is, all the sensor transceivers 2 for the four wheels 4a to 4d are under a state capable of receiving RF waves during the period of time up to the time when the vehicle-body system 3 completes the transmission of all the ID information-items on RF waves. During a period of time in which each sensor transceiver 2 is responding, RF waves are however not transmitted from the vehicle-body system 3. During such a period of time, the sensor transceiver 2 may return to be in a state incapable of receiving any RF waves, and then come to be in a state capable of receiving RF waves during the time frame during which RF waves are expected to be transmitted from the vehicle-body system 3. Further, if the RF waves including its own ID information-item have already been received, the respective sensor transceiver 2 may return to a state incapable of receiving RF waves. This can further reduce the current consumption.

Also, the configuration is described where the control unit 34c executes a startup detection process in FIG. 4 repeatedly with predetermined control cycles based on the battery voltage even when the IG is under OFF state. However, the microcomputer 34 may sometimes be turned off when the IG is under OFF state. In this case, when the microcomputer 34 is activated based on the power supply, it may be determined that the IG is switched from OFF state to ON state, and the processing after step S100 may be then executed.

Furthermore, in the above embodiment, the IG is described as an example of a startup switch operated when the vehicle 1 is started to run. This is described by taking the case where the present disclosure is applied to a vehicle with an internal combustion engine as an example; the start switch is not necessarily the IG. For example, in a case of an electric vehicle, a hybrid vehicle or the like, there are cases where the start switch is configured by a push switch or the like; the present disclosure can also be applied to such a case.

What is claimed is:

1. A tire pressure monitoring system applied to a vehicle having a vehicle body which a plurality of wheels are attached to, the plurality of wheels being equipped with and respectively corresponding to a plurality of tires,
the tire pressure monitoring system comprising:
a plurality of sensor transceivers provided to and respectively corresponding to the plurality of wheels; and
a vehicle-body system provided in the vehicle body,
each of the sensor transceivers comprising:
a sensing unit configured to detect a tire pressure of a tire of a corresponding wheel of the plurality of wheels;
a first control unit configured to prepare a frame that stores data on the tire pressure and performs transmission of the frame;
an RF reception unit configured to receive RF waves that indicate an instruction command instructing transmission of the data on the tire pressure; and
an LF reception unit configured to receive LF waves that indicate a start command to cause the RF reception unit to be in a state capable of receiving RF waves,
the vehicle-body system comprising:
a reception unit configured to receive received frames that are frames transmitted respectively from the sensor transceivers;
a second control unit configured to detect tire pressures of the tires of the plurality of wheels respectively based on the received frames;
an LF transmission unit configured to transmit LF waves;
an RF transmission unit configured to transmit RF waves,
wherein in the vehicle-body system, upon detecting that a start switch manipulated to cause the vehicle to start to run is switched from OFF state into ON state, the second control unit
causes the LF transmission unit to transmit LF waves, and,
then, causes the RF transmission unit to transmit RF waves during a predetermined period of time,
wherein in each of the sensor transceivers, upon receiving LF waves via the LF reception unit, the first control unit
causes the RF reception unit to be in a state capable of receiving RF waves,
causes the RF reception unit to receive RF waves transmitted after receiving the LF waves, and
performs transmission of the frame as a response to the received RF waves.

2. The tire pressure monitoring system according to claim 1,
wherein in the vehicle-body system, the second control unit
assigns sequentially the sensor transceivers, respectively, with corresponding unique identification information-items and
performs transmissions of RF waves containing the corresponding unique identification information-items to the sensor transceivers, respectively, during mutually different transmission time frames;
wherein in a respective sensor transceiver of the sensor transceivers, upon receiving LF waves,
the first control unit
causes the RF reception unit to be in the state capable of receiving RF waves during the predetermined period of time and
performs the transmission of the frame in response to that the received RF waves include a corresponding unique identification information-item of the respective sensor transceiver including the first control unit.

3. The tire pressure monitoring system according to claim 2,
wherein the first control unit causes the RF reception unit to be in the state capable of receiving RF waves, as during the predetermined period of time, during a period of time until the second control unit completes transmissions of RF waves to all of the sensor transceivers respectively provided in the plurality of wheels.

4. The tire pressure monitoring system according to claim 2,
wherein in a respective sensor transceiver of the sensor transceivers,
the RF reception unit
is caused to be in the state capable of receiving RF waves, as during the predetermined period of time, during a transmission time frame during which transmission of RF waves is performed by the second control unit to the respective sensor transceiver of the sensor transceivers respectively provided in the plurality of wheels, and
is caused to return to be a state incapable of receiving RF waves during a period of time during which the first control unit performs the transmission of the frame as a response to receiving the RF waves.
